(19) United States
(12) Patent Application Publication
(10) Pub. No.: US 2021/0021116 A1
(43) Pub. Date: Jan. 21, 2021

(54) Retractable Charging Device

(71) Applicant: Gail Johnson, Hollis, NY (US)

(72) Inventor: Gail Johnson, Hollis, NY (US)

(21) Appl. No.: 16/515,703

(22) Filed: Jul. 18, 2019

(51) Int. Cl. H02G 11/02; H01R 13/66; H01R 33/94; H02J 7/00; H02J 7/02; F21V 33/00

(52) U.S. Cl. CPC H02G 11/02; H01R 13/6675; H01R 33/94; F21Y 2115/10; H02J 7/02; F21V 33/0004; H02J 7/0042

(57) ABSTRACT

A retractable charging device for bridging a distance from an electronic device to an outlet includes a housing. A retractor is coupled to and positioned in the housing. A cable is operationally coupled to the retractor so that the cable is selectively extensible from the housing. The retractor is positioned to selectively retract the cable into the housing. A coupler that is coupled to a terminus of the cable is configured to operationally couple the cable to an electronic device of a user. A cord that is coupled to and extends from the housing is operationally coupled to the cable. A power supply, which is AC to DC type, is operationally coupled to the cord. A connector that is coupled to the cord is configured to couple the power supply to a source of alternating current to recharge a battery of the electronic device of the user.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to charging devices and more particularly pertain to a new charging device for bridging a distance from an electronic device to an outlet.

### BRIEF SUMMARY OF THE INVENTION

An embodiment of the disclosure meets the needs presented above by generally comprising a housing. A retractor is coupled to and positioned in the housing. A cable is operationally coupled to the retractor so that the cable is selectively extensible from the housing. The retractor is positioned to selectively retract the cable into the housing. A coupler that is coupled to a terminus of the cable is configured to operationally couple the cable to an electronic device of a user. A cord that is coupled to and extends from the housing is operationally coupled to the cable. A power supply, which is AC to DC type, is operationally coupled to the cord. A connector that is coupled to the cord is configured to couple the power supply to a source of alternating current to recharge a battery of the electronic device of the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a retractable charging device according to an embodiment of the disclosure.

FIG. 2 is a top view of an embodiment of the disclosure.

FIG. 3 is a side view of an embodiment of the disclosure.

FIG. 4 is a bottom view of an embodiment of the disclosure.

FIG. 5 is a cross-sectional view of an embodiment of the disclosure.

### DETAILED DESCRIPTION OF THE INVENTION

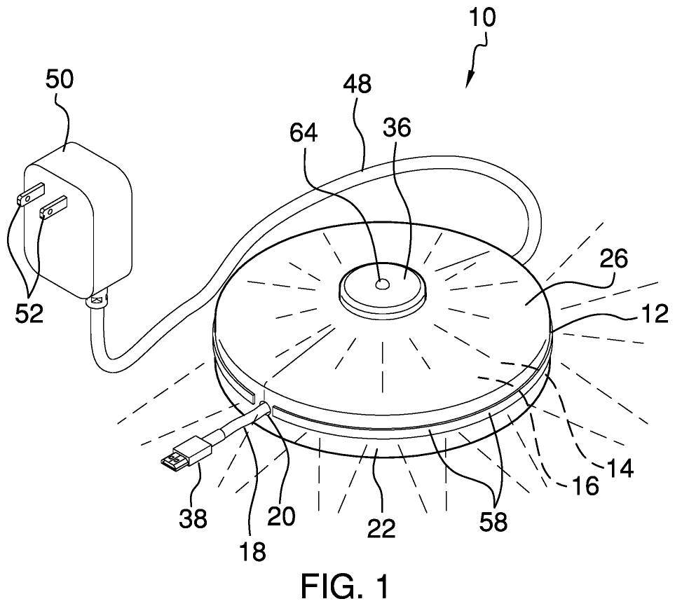

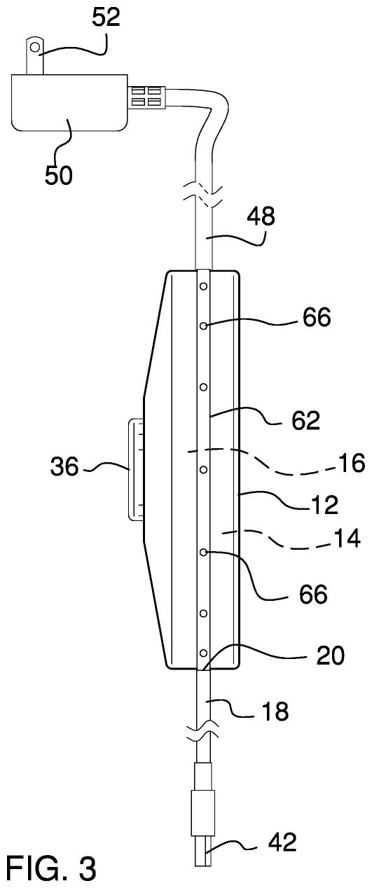

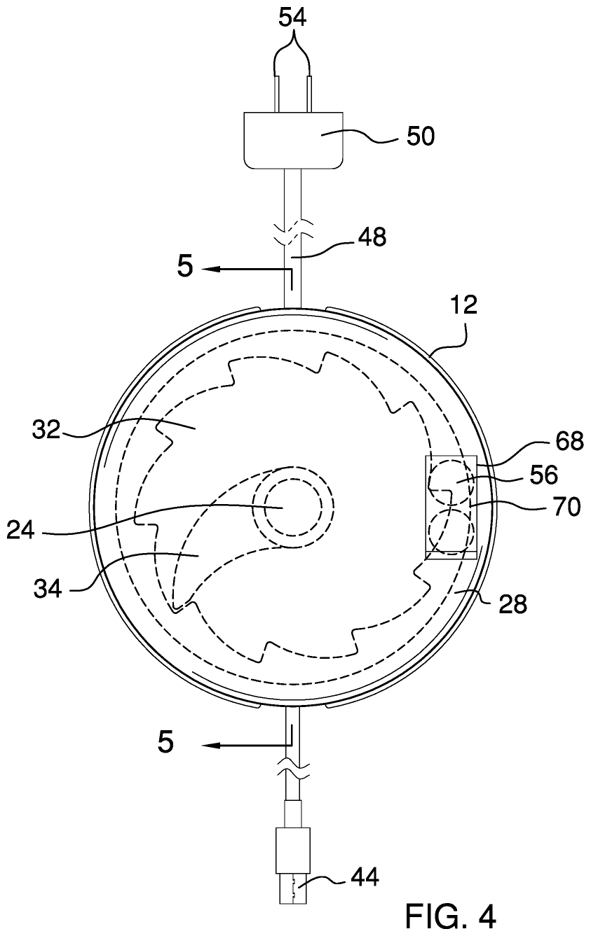

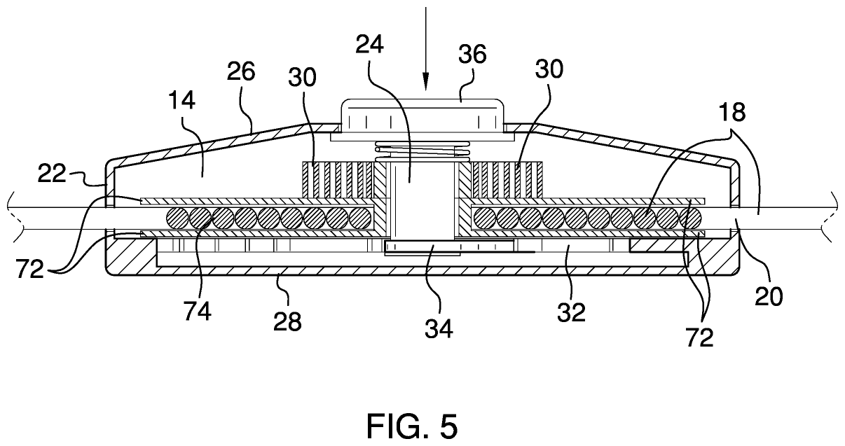

With reference now to the drawings, and in particular to FIGS. 1 through 5 thereof, a new charging device embodying the principles and concepts of an embodiment of the disclosure and generally designated by the reference numeral 10 will be described.

As best illustrated in FIGS. 1 through 5, the retractable charging device 10 generally comprises a housing 12 that defines an interior space 14. The housing 12 is substantially disc shaped. A retractor 16 is coupled to the housing 12 and is positioned in the interior space 14.

A cable 18 is operationally coupled to the retractor 16 so that the cable 18 is selectively extensible from the housing 12 through an orifice 20 that is positioned in the housing 12. The retractor 16 is positioned to selectively retract the cable 18 into the interior space 14. The cable 18 is extensible up to 3.0 meters from the housing 12. The cable 18 is extensible up to 2.0 meters from the housing 12. The cable 18 is extensible up to 1.0 meters from the housing 12. The orifice 20 is positioned in a sidewall 22 of the housing 12.

The retractor 16 comprises a shaft 24 that is positioned in the interior space 14 and which is rotationally coupled to a top 26 and a bottom 28 of the housing 12. A pair of hubs 72 is coupled to and extends radially from the shaft defining a slot 74. The cable 18 is coupled to and is selectively loopedly positionable around the shaft 24 within the slot 74. A spring 30, which is coil type, is operationally coupled to the shaft 24. The spring 30 is configured to be tensioned as the cable 18 is uncoiled from the shaft 24 and extended from the housing 12 through the orifice 20.

A ratchet wheel 32 that is positioned in the interior space 14 is coupled to the shaft 24. A pawl 34 that is positioned in the interior space 14 is pivotally coupled to the housing 12. The pawl 34 is selectively operationally couplable to the ratchet wheel 32 so that the pawl 34 is positioned to intermittently engage the ratchet wheel 32 to allow a user to extend the cable 18 from the housing 12.

A button 36, which is depressible and spring loaded, is coupled to the housing 12. The button 36 is operationally coupled to the pawl 34. The button 36 is configured to be depressed to disengage the pawl 34 from the ratchet wheel 32 so that the cable 18 is retracted into interior space 14. The button 36 is substantially centrally positioned on the top 26 of the housing 12.

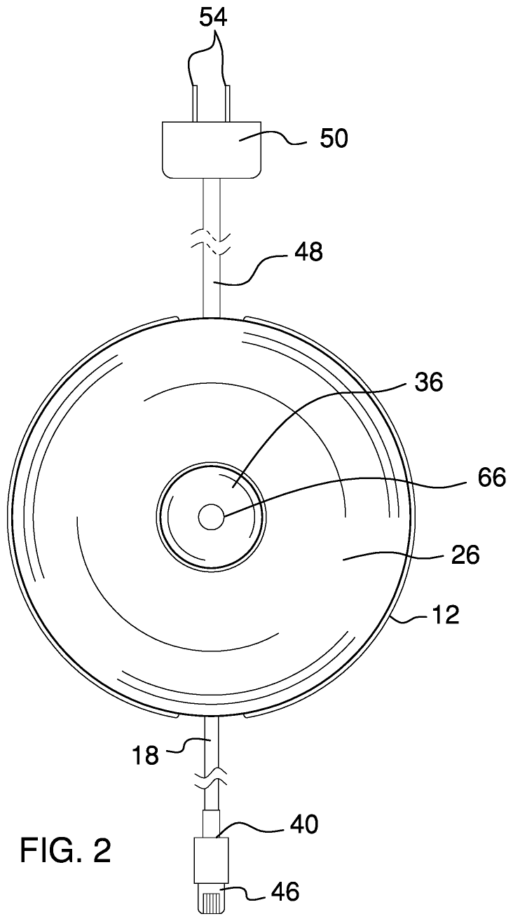

A coupler 38 is coupled to a terminus 40 of the cable 18 that is external to the housing 12. The coupler 38 is configured to operationally couple the cable 18 to an electronic device of the user. The coupler 38 comprises at least one of a direct current (DC) power connector (not shown) and a combination computer bus and DC power connector 42. The coupler 38 may comprise a Universal Serial Bus plug 44, as shown in FIG. 1, a Lightening® connector 46, as shown in FIG. 2, or other type of DC power connector or combination computer bus and DC power connector 42 such as, but not limited to, concentric barrel connectors, Tamiya connectors, snap and lock power connectors, Molex connectors, and the like.

A cord 48 is coupled to and extends from the housing 12. The cord 48 is operationally coupled to the cable 18. A power supply 50 is operationally coupled to the cord 48. The power supply 50 is alternating current (AC) to DC type so that the power supply 50 is configured to transform and to rectify alternating current.

A connector 52 is coupled to the cord 48. The connector 52 is configured to couple the power supply 50 to a source of alternating current to recharge a battery of the electronic device of the user. The connector 52 may comprise a Type A plug 54, as shown in FIG. 2, or other type of power plug such as, but not limited to, Type B plugs, Type C plugs and the like. The connector 52 is integral to the power supply 50, as shown in FIG. 2.

A battery 56 is coupled to the housing 12 and is positioned in the interior space 14. A plurality of first bulbs 58 is coupled to the housing 12 and is operationally coupled to the battery 56. The plurality of first bulbs 58 is configured to illuminate an area proximate to the housing 12. Each first bulb 58 comprises a first light emitting diode 60. The plurality of first bulbs 58 extends substantially around a circumference 62 of the sidewall 22.

A second bulb 64 is coupled to the button 36 and is operationally coupled to the battery 56. The second bulb 64 is configured to accentuate the button 36. The second bulb 64 comprises a second light emitting diode 66.

A cutout 68 is positioned in the housing 12 proximate to the battery 56. A panel 70 is selectively couplable to the housing 12 to close the cutout 68. The panel 70 is configured to be decoupled from the housing 12 to open the cutout 68 to replace the battery 56.

In use, the user plugs the connector 52 into an outlet to couple the power supply 50 to the source of alternating current and then extends the cable 18 from the housing 12. The user connects the cable 18 to the electronic device using the coupler 38 to recharge the battery of the electronic device. When stowing of the cable 18 is desired, the user simply pushes the button 36.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A retractable charging device comprising:
a housing defining an interior space;
a cable operationally coupled to a retractor coupled to the housing and positioned in the interior space such that the cable is selectively extensible from the housing through an orifice positioned in the housing and such that the retractor is positioned for selectively retracting the cable into the interior space;
a coupler coupled to a terminus of the cable external to the housing wherein the coupler is configured for operationally coupling the cable to an electronic device of a user;
a cord coupled to and extending from the housing, the cord being operationally coupled to the cable;
a power supply operationally coupled to the cord, the power supply being AC to DC type wherein the power supply is configured for transforming and rectifying alternating current; and
a connector coupled to the cord wherein the connector is configured for coupling the power supply to a source of alternating current for recharging a battery of the electronic device of the user.

2. The device of claim 1, further including the housing being substantially disc shaped

3. The device of claim 1, further including the cable being extensible up to 3.0 meters from the housing.

4. The device of claim 3, further including the cable being extensible up to 2.0 meters from the housing.

5. The device of claim 4, further including the cable being extensible up to 1.0 meters from the housing.

6. The device of claim 1, further including the orifice being positioned in a sidewall of the housing.

7. The device of claim 1, further including the retractor comprising:
a shaft positioned in the interior space and rotationally coupled to a top and a bottom of the housing;
a pair of hubs coupled to and extending radially from the shaft defining a slot, the cable being coupled to and selectively loopedly positionable around the shaft within the slot;
a spring operationally coupled to the shaft, the spring being coil type wherein the spring is configured for tensioning as the cable is uncoiled from the shaft and extended from the housing;
a ratchet wheel positioned in the interior space and coupled to the shaft;
a pawl positioned in the interior space and pivotally coupled to the housing, the pawl being selectively operationally couplable to the ratchet wheel such that the pawl is positioned for intermittently engaging the ratchet wheel for extending the cable from the housing; and
a button coupled to the housing, the button being depressible, the button being spring loaded, the button being operationally coupled to the pawl wherein the button is configured for depressing for disengaging the pawl from the ratchet wheel such that the cable is retracted into interior space.

8. The device of claim 7, further including the button being substantially centrally positioned on the top of the housing.

9. The device of claim 1, further including the coupler comprising at least one of a DC power connector and a combination computer bus and DC power connector.

10. The device of claim 1, further including the connector being integral to the power supply.

11. The device of claim 7, further comprising:
a battery coupled to the housing and positioned in the interior space; and
a plurality of first bulbs coupled to the housing and operationally coupled to the battery wherein the plurality of first bulbs is configured for illuminating an area proximate to the housing.

12. The device of claim 11, further including each first bulb comprising a first light emitting diode.

13. The device of claim 11, further including the plurality of first bulbs extending substantially around a circumference of a sidewall of the housing.

14. The device of claim 11, further including a second bulb coupled to the button and operationally coupled to the battery wherein the second bulb is configured for accentuating the button.

15. The device of claim 14, further including the second bulb comprising a second light emitting diode.

16. The device of claim 11, further comprising:
a cutout positioned in the housing proximate to the battery; and
a panel selectively couplable to the housing for closing the cutout wherein the panel is configured for decoupling from the housing for opening the cutout for replacing the battery.

17. A retractable charging device comprising:
a housing defining an interior space, the housing being substantially disc shaped;
a cable operationally coupled to a retractor coupled to the housing and positioned in the interior space such that the cable is selectively extensible from the housing through an orifice positioned in the housing and such that the retractor is positioned for selectively retracting the cable into the interior space, the cable being extensible up to 3.0 meters from the housing, the cable being extensible up to 2.0 meters from the housing, the cable being extensible up to 1.0 meters from the housing, the orifice being positioned in a sidewall of the housing, the retractor comprising:
a shaft positioned in the interior space and rotationally coupled to a top and a bottom of the housing, the cable being coupled to and selectively loopedly positionable around the shaft,
a pair of hubs coupled to and extending radially from the shaft defining a slot, the cable being coupled to and selectively loopedly positionable around the shaft within the slot,
a spring operationally coupled to the shaft, the spring being coil type wherein the spring is configured for tensioning as the cable is uncoiled from the shaft and extended from the housing,
a ratchet wheel positioned in the interior space and coupled to the shaft,
a pawl positioned in the interior space and pivotally coupled to the housing, the pawl being selectively operationally couplable to the ratchet wheel such that the pawl is positioned for intermittently engaging the ratchet wheel for extending the cable from the housing, and
a button coupled to the housing, the button being depressible, the button being spring loaded, the button being operationally coupled to the pawl wherein the button is configured for depressing for disengaging the pawl from the ratchet wheel such that the cable is retracted into interior space, the button being substantially centrally positioned on the top of the housing;
a coupler coupled to a terminus of the cable external to the housing wherein the coupler is configured for operationally coupling the cable to an electronic device of a user, the coupler comprising at least one of a DC power connector and a combination computer bus and DC power connector;
a cord coupled to and extending from the housing, the cord being operationally coupled to the cable;
a power supply operationally coupled to the cord, the power supply being AC to DC type wherein the power supply is configured for transforming and rectifying alternating current;
a connector coupled to the cord wherein the connector is configured for coupling the power supply to a source of alternating current for recharging a battery of the electronic device of the user, the connector being integral to the power supply;
a battery coupled to the housing and positioned in the interior space;
a plurality of first bulbs coupled to the housing and operationally coupled to the battery wherein the plurality of first bulbs is configured for illuminating an area proximate to the housing, each first bulb comprising a first light emitting diode, the plurality of first bulbs extending substantially around a circumference of the sidewall;
a second bulb coupled to the button and operationally coupled to the battery wherein the second bulb is configured for accentuating the button, the second bulb comprising a second light emitting diode;
a cutout positioned in the housing proximate to the battery; and
a panel selectively couplable to the housing for closing the cutout wherein the panel is configured for decoupling from the housing for opening the cutout for replacing the battery.
